(19) United States
(12) Patent Application Publication
(10) Pub. No.: US 2022/0117199 A1
(43) Pub. Date: Apr. 21, 2022

(54) DOG HARNESS AND CARGO CARRIER

(71) Applicant: Dojo Ventures, LLC, Boulder, CO (US)

(72) Inventor: Doris RIGONI, Boulder, CO (US)

(21) Appl. No.: 17/501,546

(22) Filed: Oct. 14, 2021

Related U.S. Application Data
(60) Provisional application No. 63/093,355, filed on Oct. 19, 2020.

(51) Int. Cl. A01K 27/00

(52) U.S. Cl. CPC A01K 27/008; A01K 27/002

(57) ABSTRACT

An animal harness that includes a cargo receptacle having an interior volume to receive cargo (e.g., bagged solid dog waste). The harness is particularly suited for a small animal, such as a dog, and is adjustable at multiple points to comfortable fit essentially any size dog. The cargo receptacle is centered on the harness, so that when worn by an animal such as a dog, the cargo receptacle is on or above the withers or shoulder area of the animal. The cargo receptacle is attached to a base structure on the harness and can be released and removed from the harness.

### CROSS-REFERENCE

This application claims priority to U.S. provisional application No. 63/093,355 filed Oct. 19, 2020 and entitled Dog Harness and Cargo Carrier, the entire disclosure of which is incorporated herein by reference.

### BACKGROUND

Dogs are a common household pet and, arguably, the most common pet.

Especially in urban and suburban areas, dogs must be leashed when outside the owner's property. Most dogs have collars for attachment to a leash. A rambunctious or energetic dog will pull on a leash, which is unpleasant for the human but also unpleasant for the dog, as a collar often provides pressure on the throat. Many different collars, facial halters and body harnesses are available for controlling a dog.

Harnesses for dogs have been well known for many years and are useful for controlling a dog. In its simplest form, a harness is constructed of one or two straps around the torso or belly, connected at a strap around the chest. The torso strap can be configured to be placed high on the chest and rising to the top of the back. A leash is usually attached at the back.

In addition to having to physically control the dog with a leash when outside the owner's property, any solid waste left by the dog is supposed to be, and often required by law to be, picked up by the human. Very often, the human leaves the waste, often citing an inability or lack of desire to carry the waste to a location to property dispose of the waste. Occasionally, this may be due to a lack of readily accessible trash receptacles, e.g., in remote areas or when a proper disposal facility or receptacle is not nearby.

### SUMMARY

The present disclosure is directed to an animal harness that includes a removeable cargo receptacle having an interior volume to receive cargo (e.g., bagged solid dog waste). The harness is particularly suited for a small animal, such as a dog, and is adjustable at multiple points to comfortably fit essentially any size dog. The cargo receptacle is centered on the harness, so that when worn by an animal such as a dog, the cargo receptacle is on or above the withers or shoulder area of the animal. In some implementations and with some animals, the cargo receptacle may extend along the back of the animal, but is nevertheless resides on and is centered on the back of the animal, rather than depending (hanging down) along the sides of the animal as do other bags or packs. Thus, the weight of the cargo receptacle and the cargo rests directly on the back of the animal, rather than having the weight push against the sides of the animal, as it does with “saddle bags” or other hanging bags or packs. The cargo receptacle can be released and removed from the harness; the cargo receptacle may engage directly to the harness or may fit within a walled or otherwise enclosable structure on the harness.

In one particular implementation, described herein is an animal harness that has a back plate having a left side, a right side, a front end and a back end, and a chest plate having a front end and a back end. The harness includes a first adjustable length chest strap extending from the front end of the back plate to the chest plate and a second adjustable length chest strap extending from the front end of the back plate to the chest plate, and also a first adjustable length belly strap removably extending from the left side of the back plate to the back end of the chest plate and a second adjustable length belly strap removably extending from the right side of the back plate to the back end of the chest plate. A walled base structure is attached to and centered on the back plate, and a cargo receptacle having a closeable interior is releasably attached to the base.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWING

FIG. 1 is a diagram of an example animal harness on a (large) dog.

FIG. 2A is a bottom view of the example animal harness; FIG. 2B is a top view of the example animal harness; and FIG. 2C is a side view of the example animal harness, with the cargo carrier insert shown removed.

### DETAILED DESCRIPTION

As described above, the present disclosure is directed to a harness for an animal, especially for a dog, the harness configured to not only physically control the animal via a leash attachment (e.g., a 2D ring) but also provide a removable cargo container.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

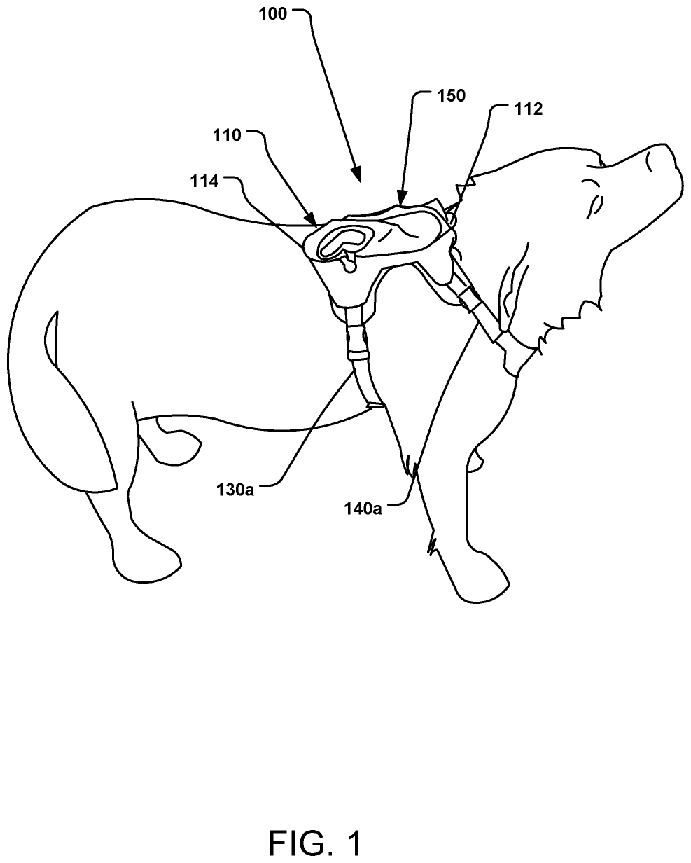

Turning to FIG. 1, a harness 100, configured to be worn by a small animal, such as a dog, is shown worn by a large dog (approximately 80 lbs). The harness 100 has a back plate 110 having a first end 112 (proximate the dog's head) and a second end 114 (proximate the dog's back) and the harness 100 also has a chest plate (not seen in FIG. 1). The harness 100 is retained on the dog by a plurality of straps, two of which as seen as strap 130a and strap 140a.

The harness 100 has a cargo receptacle 150 centered on the withers or shoulder area of the dog. When properly positioned on the animal, the cargo receptacle 150 is centered on or above the withers or shoulder area of the animal, directly behind the neck of the animal. In some implementations and with some animals, the cargo receptacle 150 may extend along the back of the animal but is nevertheless present on the withers or shoulder area. The cargo receptacle 150 is centered on and present on the top of the back of the animal, rather than depending along the sides of the animal, as do “saddle bags.”

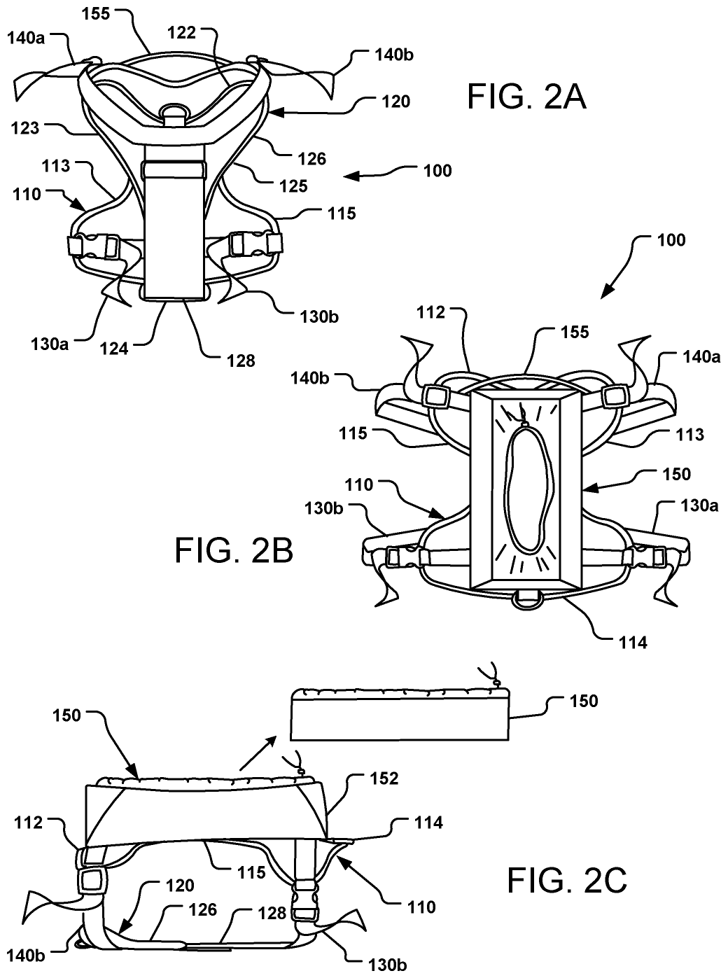

FIGS. 2A, 2B and 2C show the harness 100 from various angles. Clearly seen in these figures are the back plate 110, the chest plate 120, and the cargo receptacle 150.

The back plate 110 has a first end 112 and a second end 114 and a first side 113 and a second side 115, which when worn by the animal, the first end 112 is proximate the head and could be referred to as the front end 112, the second end 114 is closer to the tail than the first end 112 and could be referred to as the back end 114, the first side 113 is on the right side of the animal and the second side 115 is on the left side of the animal.

Similarly, the chest plate 120 has a first end 122 and a second end 124 and a first side 123 and a second side 125. When worn by an animal, the first end 122 is at or proximate the chest of the animal and could be referred to as the front end 122, the second end 124 is closer to the tail than the first end 122 and could be referred to as the back end 124, the first side 123 is on the right side of the animal and the second side 125 is on the left side of the animal.

Either or both plate 110, 120 may be rectangular in shape or may be generally rectangular with various arcuate sides. The shape of one or both plates 110, 120 may be designed to allow unhindered movement to the animal, e.g., as it is walking or running while wearing the harness 100. The plates 110, 120 are symmetrical along a longitudinal axis that extends from the first ends 112, 122 to the second ends 114, 124. Any portion or all of either plate 110, 120 may be padded.

The harness includes multiple adjustable straps that retain the back plate 110 and the chest plate 120 in relation to each other and secure the harness 100 on the animal.

A first belly strap 130a is configured to extend from the first side 113, second end 114 of the back plate 110 to the first side 123, second end 124 of the chest plate 120, and a second belly strap 130b is configured to extend from the second side 115, second end 114 of the back plate 110 to the second side 125, second end 124 of the chest plate 120. As seen best in FIG. 2A, the first strap 130a and the second strap 130b each terminate and are attached to the second end 124 of the chest plate 120, but in other implementations, the two straps 130 may be a single strap that extends around the animal from the first side 113 of the back plate 110 to the second side 115, such a single strap may be attached to or slidable or otherwise moveable in relation to the chest plate 120 proximate the second end 124.

A first chest strap 140a is configured to extend from the first side 113, first end 112 of the back plate 110 to the first side 123, first end 122 of the chest plate 120, and a second chest strap 140b is configured to extend from the second side 115, first end 112 of the back plate 110 to the second side 125, first end 122 of the chest plate 120. As seen best in FIG. 2A, the first strap 140a and the second strap 140b are formed by a single strap that extends from the first side 113 to the second side 115; the strap 140 may be attached to or slidable or otherwise moveable in relation to the first end 122 of the chest plate 130. In other implementations, the first strap 140a and the second strap 140b are individual straps that each terminates at the chest plate 120.

At least some of the straps 130, 140 are releasably attached to one or both of the back plate 110 and the chest plate 120. The connection attachment between the strap 130, 140 and the plate 110, 120 may be, e.g., a buckle, a snap, a quick-release clip, a hook-and-loop fastener or similar system. In the particular example harness 100, best seen in FIG. 2C, the belly straps 130 are releasable from the back plate 110 via a quick-release clip, but the chest straps 140 are not releasable, as it is generally readily feasible to have an animal, particularly a dog, place their head through the aperture formed by the straps 140 at the first (front) ends 112, 122 of the back plate 110 and chest plate 120.

In use, when the harness 100 is worn by an animal as shown in FIG. 1, the belly straps 130 extend around the torso of the animal, one strap 130 on each side of the animal proximate the animal's rib cage, and one chest strap 140 is positioned in front of each leg, each strap 140 extending between the front of the front leg and the animal's neck.

Each of the straps 130, 140 may have an adjustable length to allow for sizing of the harness 100 to the animal. The length adjustments may be stepped or incremental (e.g., a buckle that engages with holes in the strap), or may be continuous (e.g., via a slider as seen on the straps 140 in FIG. 2B and FIG. 2C). By having an adjustment feature on each of the straps 130, 140, four points of size adjustment of the harness 100 are possible. In the example harness 100, the adjustment feature on the belly straps 130 is a slider integrated with the attachment feature (e.g., the clip) and the adjustment feature on the chest straps 140 is a slider.

In the particular example shown, best seen in FIG. 2A, the chest plate 120 is composed of a padded portion 126 that has a wider dimension (from the first side 123 to the second side 125) than a non-padded portion 128. The padded portion 126, in this example, has a generally triangular shape with arcuate edges, and the non-padded portion 128 has an elongate, rectangular shape; of course, other shapes can be used. The portions 126, 128 may be integral with each other, or may be two different pieces attached to each other. In the particular example shown, the non-padded portion 128 overlaps onto the padded portion 126. In this example, the non-padded portion 128 is a strap or webbing (e.g., grosgrain), and includes an adjustment mechanism (e.g., a slider) to adjust the length between the first end 122 and the second end 124. By including an adjustment feature on the chest plate 120, the harness 100 has one more point of size adjustment. Thus, if all four straps 130, 140 and the chest plate 120 are adjustable, the harness 100 has five points of size adjustment.

The plates 110, 120 are preferably formed with a durable material, such as a high denier material, such as Cordura®, ballistic, or ripstop nylon. A reflective material may be present on one or both of the plates 110, 120. Padding may be included in either or both plates 110, 120. The plates 110, 120 are shaped to comfortably conform to the anatomy of the animal, providing solid connection and stability, yet allowing full movement (e.g., of the animal's shoulders).

The straps 130, 140 are likewise preferably formed with a durable material, such as a high denier webbing (e.g., grosgrain). Although possible, the straps 130, 140 are preferably not elastic or otherwise stretchable, and could include reflective material. The non-padded portion 128 of the chest plate 120 may be of a similar material as the straps 130, 140, with dimensions of the straps 130, 140 and portion 128 adjusted accordingly.

The harness 100 includes a cargo receptacle 150 at or on the back plate 110. The cargo receptacle 150 is a flexible container, e.g., a bag or a soft-sided box with a flexible top, that has a sealable or closable access opening to the interior volume of the receptacle 150. For example, the access opening may have a draw string to reduce the area of the access opening and optionally closing the opening; it is noted that “closed” and variations thereof does not necessarily mean airtight or watertight. The receptacle 150 is shaped and sized to have an interior volume to receive and maintain items including, but not limited to, snacks or treats (for humans or dogs), leashes, plastic bags, and bagged solid waste (e.g., having been deposited on the ground by the animal and picked up by the human in, e.g., a plastic bag).

The bottom area of the cargo receptacle 150 is essentially no greater than the area of the back plate 110, so that the cargo receptacle 150 resides on the back plate 110. That is, no major portion of the cargo receptacle 150 extends outside of the perimeter of the back plate 110 (the perimeter defined by first end 112, second end 114, first side 113, second side 115).

The cargo receptacle 150 can be releasable/attachable to the back plate 110, e.g., by hook-and-loop, clip(s), snaps, etc. The receptacle 150 may be directly attached to the back plate 110 or, for example, to a foundation or base 152 (FIG. 2C) that may be integral with the back plate 110. The base 152 may have a lip or walls (either flexible, rigid, or semi-rigid) defining a region in which the receptacle 150 is received. In one particular example, the base 152 is a walled structure and has one member of a hook-and-loop fastener around its walled periphery and the flexible receptacle 150 has the mating hook-and-loop fastener around its periphery proximate the bottom of the receptacle 150, so that when engaged, the receptacle 150 is held firmly to the base 152 of the back plate 110. In another example, the base is integral with the back plate 110 (e.g., it may be formed by the back plate 110) and has one member of a hook-and-loop fastener flat on the base and the flexible receptacle 150 has the mating hook-and-loop fastener on the bottom of the receptacle 150.

The receptacle 150 can be used to temporarily store or carry any number of items, for example, snacks or treats (for humans or animals), leashes, plastic bags, and bagged solid waste (e.g., having been deposited on the ground and picked up by the human in, e.g., a plastic bag). If the receptacle 150 is at least partially watertight or water resistant, it can be removed from the base 152 and used as a drinking bowl for the animal. Additionally, in situations when the human has no access to a plastic bag or other material with which to pick up their dog's solid waste, the receptacle 150 can be used. By having the receptacle 150 removable from the base 152 and the back plate 110 and the harness 100, the receptacle 150 can be thoroughly washed or otherwise cleaned, dried, etc.

When not in use, for example, the cargo receptacle 150 can be removed from the base 152 and the harness 100 can be used without the receptacle 150. Alternately, the receptacle 150 can be compressed or otherwise reduced in height, and held in a reduced position, e.g., by strap(s), snap(s) or clip(s).

One or more leash attachment rings or features may be present on the harness 100. In FIG. 2A, a D-ring is seen at the first (front) end 122 of the chest plate 120. Other common locations for rings are the second (back) end 114 of the back plate 110 (see, e.g., FIG. 2B). D-rings or loops may be positioned anywhere on the harness 100 to receive additional items hooked thereto, e.g., water bottle, (collapsible) water bowl, hand sanitizer tube, roll of plastic bags, etc. A handle 155 may be present, e.g., on the back plate 110, for occasions when it may be desired to grab the harnessed animal for better control.

Thus, described herein is a cargo-carrying harness for use with an animal, such as a companion animal (e.g., dog, cat, rabbit). The cargo receptacle is removable and replaceable onto the harness. The harness has at least four points of size adjustment, in some designs, five points of size adjustment.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. Features and elements from one implementation or embodiment may be readily applied to a different implementation or embodiment. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

1. An animal harness comprising:
a back plate having a left side, a right side, a front end and a back end, and a chest plate having a front end and a back end,
two adjustable length chest straps extending from the front end of the back plate to the chest plate defining an opening for passing an animal's head therethrough,
two adjustable length belly straps removably extending from the left side and the right side of the back plate to the back end of the chest plate, and
a cargo receptacle having a closeable interior, the cargo receptacle releasably attached to and centered on the back plate, the cargo receptacle having a bottom surface area no greater than an area of the back plate defined by the left side, the right side, the front end and the back end.

2. The animal harness of claim 1, wherein the back plate has a padded portion and the chest plate has a padded portion and an adjustable length portion.

3. The animal harness of claim 1, wherein the cargo receptacle is releasably attached to the back plate via hook-and-loop fasteners.

4. The animal harness of claim 1, wherein the cargo receptacle is releasably attached to a base on the back plate.

5. The animal harness of claim 4, wherein the base on the back plate includes a walled structure retaining the cargo receptacle therein.

6. The animal harness of claim 5, wherein the cargo receptacle is releasably attached to the walled structure via hook-and-loop fasteners.

7. The animal harness of claim 1, wherein the cargo receptacle is at least water resistant.

8. The animal harness of claim 1, the cargo receptacle comprising a draw string for providing access to the interior.

9. The animal harness of claim 1, further comprising a handle connected to the back plate.

10. The animal harness of claim 1, further comprising at least one D-ring.

11. An animal harness comprising:
a back plate having a left side, a right side, a front end and a back end, and a chest plate having a front end and a back end,
a first adjustable length chest strap extending from the front end of the back plate to the chest plate and a second adjustable length chest strap extending from the front end of the back plate to the chest plate,
a first adjustable length belly strap removably extending from the left side of the back plate to the back end of the chest plate and a second adjustable length belly strap removably extending from the right side of the back plate to the back end of the chest plate,
a walled base attached to and centered on the back plate, and
a cargo receptacle having a closeable interior, the cargo receptacle releasably attached to the base.

12. The animal harness of claim 11, wherein the back plate has a padded portion and the chest plate has a padded portion and an adjustable length portion.

13. The animal harness of claim 11, wherein the cargo receptacle is releasably attached to the base via hook-and-loop fasteners.

14. The animal harness of claim 11, wherein the cargo receptacle is at least water resistant.

15. The animal harness of claim 11, the cargo receptacle comprising a draw string for providing access to the interior.

16. The animal harness of claim 11, further comprising a handle connected to the back plate.

17. The animal harness of claim 11, further comprising at least one D-ring.
